(19) United States
(12) Patent Application Publication
(10) Pub. No.: US 2022/0222746 A1
(43) Pub. Date: Jul. 14, 2022

(54) EXECUTION METHOD AND INFORMATION PROCESSING APPARATUS

(71) Applicant: FUJITSU LIMITED, Kawasaki-shi (JP)

(72) Inventors: Toshihiro Shimizu, Kawasaki (JP); Akihito Nakamura, Shinagawa (JP); Akihiro Kuwabara, Meguro (JP); Motohiro Kosaki, Kawasaki (JP)

(73) Assignee: FUJITSU LIMITED, Kawasaki-shi (JP)

(21) Appl. No.: 17/524,885

(22) Filed: Nov. 12, 2021

(30) Foreign Application Priority Data
Jan. 12, 2021 (JP) 2021-002861

(51) Int. Cl. G06Q 40/04; G06F 7/535

(52) U.S. Cl. CPC G06Q 40/04; G06F 7/535

(57) ABSTRACT

A non-transitory computer-readable recording medium stores an execution program for causing a computer to execute a process, the process includes accepting orders to each of which a condition of a number of executions is designated, setting the accepted orders as respective polynomials using the designated number of executions in the condition as a degree, representing an order status in which the accepted orders are combined as a polynomial on a finite field according to a product of the polynomials, dividing the polynomial on the finite field by a polynomial that corresponds to an order to be executed or canceled, and updating the polynomial on the finite field to a resulted polynomial after the division.

### CROSS-REFERENCE TO RELATED APPLICATION

This application is based upon and claims the benefit of priority of the prior Japanese Patent Application No. 2021-2861, filed on Jan. 12, 2021, the entire contents of which are incorporated herein by reference.

### FIELD

The embodiment discussed herein is related to an execution method.

### BACKGROUND

In the securities market, establishment of a trade such as stock trading is referred to as “execution”. For example, a state where a condition of a user who has placed a sell order matches a condition of a user who has placed a buy order and transaction has been closed is referred to as an execution. In a case where a user places an order (sell order or buy order), there is a case where an order is placed under conditions such as a full-volume execution or a certain number of orders.

In the following description, the condition set to the order that is the minimum number of executions is referred to as the “minimum number of executions”. For example, in a case where there are a sell order of which the number of orders is “N” with a condition of the minimum number of executions “M” and a buy order of which the number of orders is equal to or more than “M”, transaction is closed. There is related art that obtains an execution through matching using dynamic programming between the sell order and the buy order to which such a minimum number of executions is set.

Japanese National Publication of International Patent Application No. 2014-531695, Japanese Laid-open Patent Publication No. 2003-99610, and Japanese Laid-open Patent Publication No. 2020-42738 are disclosed as related art.

### SUMMARY

According to an aspect of the present embodiment, a non-transitory computer-readable recording medium stores an execution program for causing a computer to execute a process, the process includes accepting orders to each of which a condition of a number of executions is designated, setting the accepted orders as respective polynomials using the designated number of executions in the condition as a degree, representing an order status in which the accepted orders are combined as a polynomial on a finite field according to a product of the polynomials, dividing the polynomial on the finite field by a polynomial that corresponds to an order to be executed or canceled, and updating the polynomial on the finite field to a resulted polynomial after the division.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for explaining processing in dynamic programming in a case where a sell order is accepted;

FIG. 2 is an explanatory diagram for explaining processing in the dynamic programming in a case where a buy order is accepted;

FIG. 3 is an explanatory diagram for explaining processing in the dynamic programming for calculating the number of executions;

FIG. 4 is an explanatory diagram for explaining processing in the dynamic programming in a case where a sell order is accepted;

FIG. 5 is an explanatory diagram for explaining processing in the dynamic programming for specifying execution target orders;

FIG. 6 is an explanatory diagram for explaining a case where an order status is represented by a polynomial;

FIG. 7 is an explanatory diagram for explaining a case where an order status is represented by a polynomial;

FIG. 8 is an explanatory diagram for explaining division in a case where an order status is represented by a polynomial;

FIG. 9 is a block diagram illustrating an exemplary functional configuration of an information processing apparatus according to an embodiment;

FIG. 10 is an explanatory diagram illustrating an example of a data structure of a sell order table;

FIG. 11 is an explanatory diagram illustrating an example of a data structure of a buy order table;

FIG. 12 is an explanatory diagram illustrating an example of a data structure of execution result information;

FIG. 13 is a flowchart illustrating an example of order acceptance and cancellation processing;

FIG. 14 is a flowchart illustrating an example of execution processing; and

FIG. 15 is a block diagram illustrating an exemplary hardware configuration of a computer that implements functions similar to those of the information processing apparatus according to the embodiment.

### DESCRIPTION OF EMBODIMENT

The related art described above has a problem in that, because data of an order status regarding remaining orders after an order is canceled or execution is completed needs to be reconstructed each time, it is inefficient to specify orders to be executed (execution target orders).

Hereinafter, an execution method and an information processing apparatus according to an embodiment will be described with reference to the drawings. Configurations having the same functions in the embodiment are denoted by the same reference signs, and redundant description will be omitted. Note that the execution method and the information processing apparatus to be described in the embodiment below are merely examples and do not limit the embodiment.

First, processing according to the dynamic programming will be described that obtains an execution by matching a sell order and a buy order to which the minimum number of executions is set. In the processing for specifying execution target orders using the dynamic programming, a Bool (T, F) array is prepared so as to manage each of the sell orders or the buy orders, and the execution target orders are specified such that the number of executions is maximized.

The Bool (T, F) array is referred to as an “array_a”. An index i that is equal to or more than zero is set to the array_a, and “T” or “F” is set to an element corresponding to the index i of the array_a. In a case where the element corresponding to the index i of the array_a is “T”, this means that there are orders with the number of orders i. In a case where the element corresponding to the index i of the array_a is “F”, this means that there is no order with the number of orders i. The letter “T” is an example of a registration symbol.

Array_a [i]=T indicates that the element corresponding to the index i of the array_a is “T”. Array_a [i]=F indicates that the element corresponding to the index i of the array_a is “F”.

Here, an array_a that stores information regarding sell orders is referred to as a “first array_a”, and an array_a that stores information regarding buy orders is referred to as a “second array_a”.

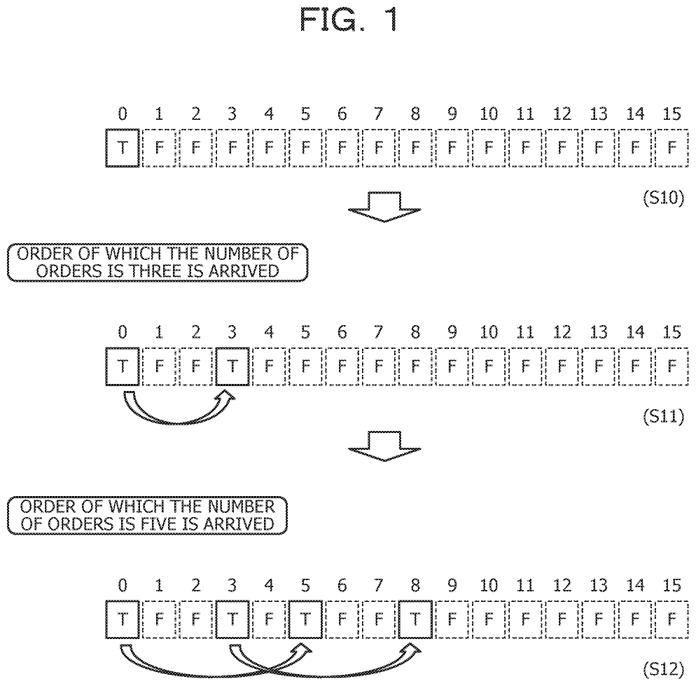

FIG. 1 is an explanatory diagram for explaining processing in the dynamic programming in a case where a sell order is accepted and illustrates a state of the first array_a in a case where the sell order is accepted. In a case where a sell order with the number of orders x is accepted when first array_a [i]=T, the information processing apparatus sets the first array_a to first array_a [i+x]=T.

It is assumed that an initial state of the first array_a be as indicated in step S10. In the initial state of the first array_a, first array_a [0]=T, and all other elements of the first array_a are set to “F”.

In a case where a sell order of which the number of orders is three is accepted in this state, the state of the first array_a is as indicated in step S11. Because the first array_a is set as first array_a [0]=T, the information processing apparatus sets the first array_a to first array_a [0+3]=T.

In a case where an order of which the number of orders is five is further accepted in this state, the state of the first array_a is as indicated in step S12. Because the first array_a is set as first array_a [0]=T, the information processing apparatus sets the first array_a to first array_a [0+5]=T. Because the first array_a is set as first array_a [3]=T, the information processing apparatus sets the first array_a to first array_a [3+5]=T.

An index of which an element of the first array_a is T indicates an execution volume that may be matched. For example, in the state of the first array_a in step S12 in FIG. 1, an element of the index i=8 is “T”, and the “8” is the number such that all the number of orders “3” and the number of orders “5” are executed.

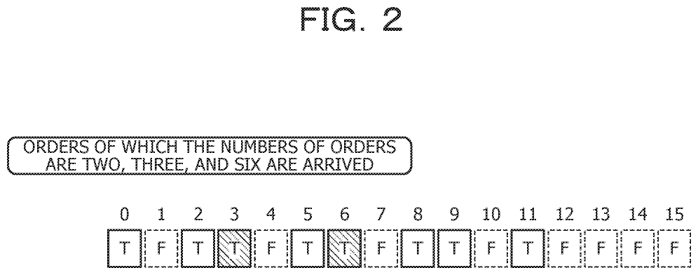

FIG. 2 is an explanatory diagram for explaining processing in the dynamic programming in a case where a buy order is accepted and illustrates a state of the second array_a in a case where the buy order is accepted. As in the processing on the first array_a in a case where the sell order is accepted described with reference to FIG. 1, in a case where a buy order with the number of orders x is accepted when second array_a [i]=T, the information processing apparatus sets the second array_a to second array_a [i+x]=T. In an initial state of the second array_a, second array_a [0]=T, and all other elements of the second array_a are set to “F”.

For example, in a case where a buy order of which the number of orders is two, a buy order of which the number of orders is three, and a buy order of which the number of orders is six are accepted in this order, the state of the second array_a is as indicated in FIG. 2. In other words, for example, second array_a [0]=T, second array_a [2]=T, second array_a [3]=T, second array_a [5]=T, second array_a [6]=T, second array_a [8]=T, second array_a [9]=T, and second array_a [11]=T, and other elements of the second array_a are set to “F”.

The information processing apparatus compares the first array_a of sell orders described with reference to FIG. 1 with the second array_a of buy orders described with reference to FIG. 2 and specifies the maximum execution volume that may be matched.

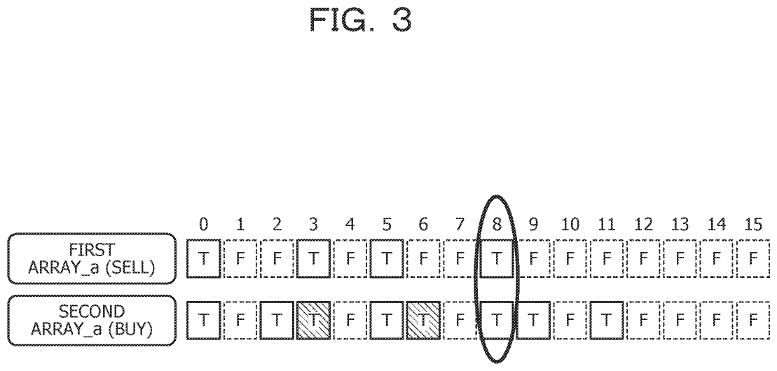

FIG. 3 is an explanatory diagram for explaining processing in the dynamic programming for calculating the number of executions. The information processing apparatus compares the first array_a with the second array_a and specifies the largest index among indexes of which both of the element of the first array_a and the element of the second array_a are “T” as the maximum number of executions. In the example illustrated in FIG. 3, since the largest index among the indexes of which both of the element of the first array_a and the element of the second array_a are “T” is “8”, the information processing apparatus calculates “8” as the maximum execution volume that may be matched.

Subsequently, processing for specifying execution target orders by the information processing apparatus will be described. The information processing apparatus may specify execution target orders by registering auxiliary information that indicates an order acceptance sequence (order sequence) and a volume (the number of orders) for each index in a case where the information processing apparatus accepts an order and sets “T” to the relevant element of the array_a for the first time.

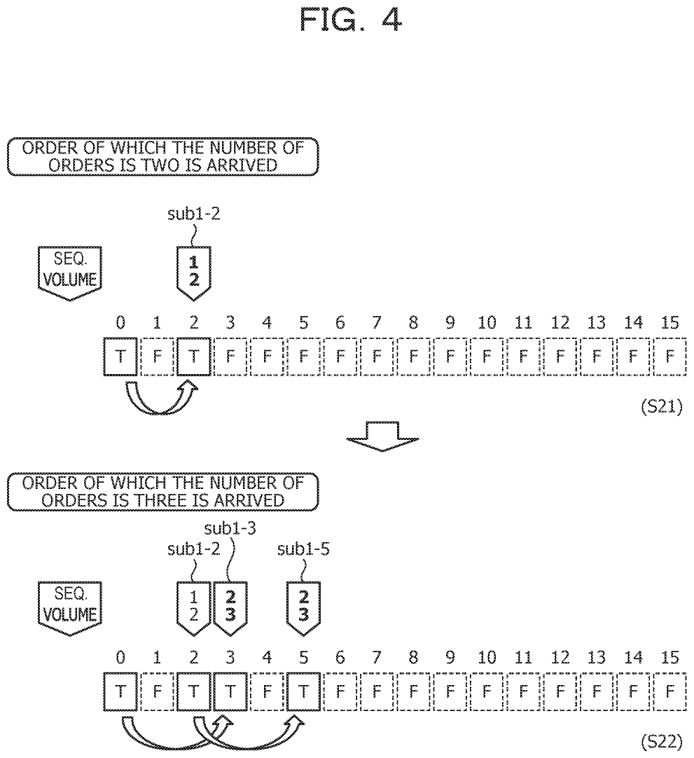

FIG. 4 is an explanatory diagram for explaining processing in the dynamic programming in a case where a sell order is accepted. In FIG. 4, the initial state of the first array_a is not illustrated. However, the initial state of the first array_a corresponds to the state of the first array_a in step S10 described with reference to FIG. 1. The information processing apparatus does not add the auxiliary information to the element that is set as “T” in the initial state. Note that an order acceptance sequence of a sell order corresponds to a “first order sequence”, and the number of orders of sell orders corresponds to a “first number of orders”.

In a case where a sell order of which the number of orders is two is accepted first (order acceptance sequence=1), the state of the first array_a is as indicated in step S21. Since the first array_a in the initial state is set as first array_a [0]=T, the information processing apparatus sets the first array_a to first array_a [0+2]=T. Furthermore, auxiliary information sub1-2 is set to the index i=2. A sequence (denoted by “SEQ.” in the drawings) “1” and a volume “2” are set to the auxiliary information sub1-2.

Subsequently (order acceptance sequence=2), in a case where a sell order of which the number of orders is three is accepted, the state of the first array_a is as indicated in step S22. Because the first array_a is set as first array_a [0]=T, the information processing apparatus sets the first array_a to first array_a [0+3]=T and registers auxiliary information sub1-3 for index i=3. A sequence “2” and a volume “3” are set to the auxiliary information sub1-3.

Because the first array_a is set as first array_a [2]=T, the information processing apparatus sets the first array_a to first array_a [2+3]=T and registers auxiliary information sub1-5 for index i=5. A sequence “2” and a volume “3” are set to the auxiliary information sub1-5.

Although not illustrated, in a case of accepting a buy order, the information processing apparatus sets “T” to the element of the second array_a and registers auxiliary information for an index as in FIG. 4. Note that an order acceptance sequence of a buy order corresponds to a “second order sequence”, and the number of orders of buy orders corresponds to a “second number of orders”.

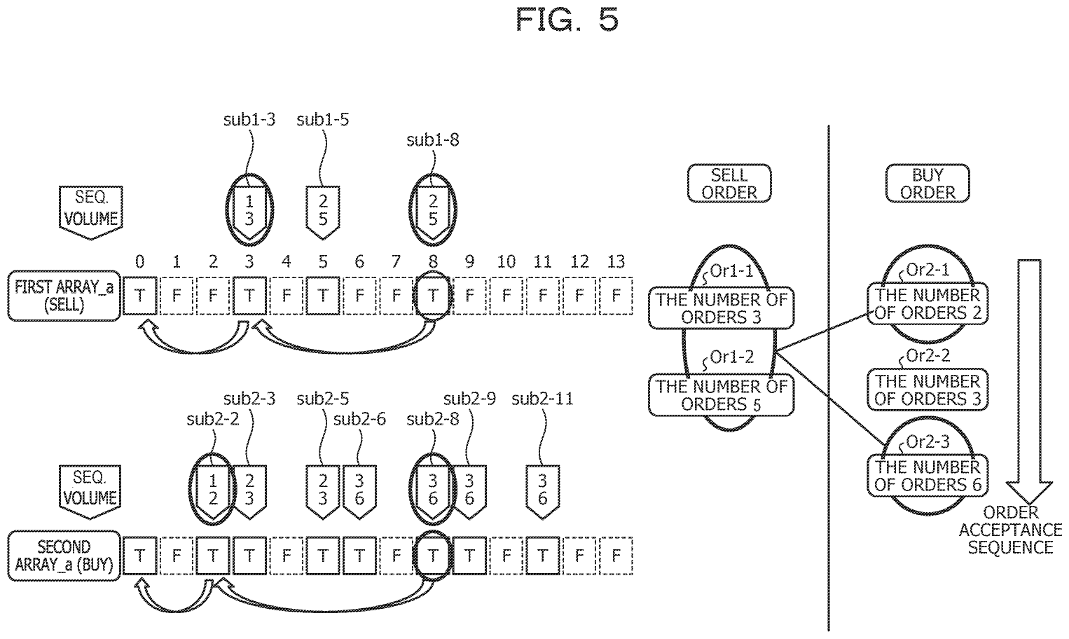

FIG. 5 is an explanatory diagram for explaining processing in the dynamic programming for specifying execution target orders. In FIG. 5, the information processing apparatus sequentially accepts orders Or1-1 and Or1-2 as sell orders. The order Or1-1 is an order of which the number of orders is “3”. The order Or1-2 is an order of which the number of orders is “5”. The information processing apparatus sequentially accepts orders Or2-1, Or2-2, and Or2-3 as buy orders. The order Or2-1 is an order of which the number of orders is “2”. The order Or2-2 is an order of which the number of orders is “3”. The order Or2-3 is an order of which the number of orders is “6”.

When sequentially accepting the orders Or1-1 and Or1-2, the information processing apparatus sets the first array_a to a state as illustrated in FIG. 5 by executing the processing on the first array_a in a case where a sell order is accepted. The elements of the indexes i=0, 3, 5, and 8 of the first array_a are set to “T”, and other elements of the first array_a are set to “F”. “T” of the index i=0 is set in the initial state.

The information processing apparatus sets the auxiliary information sub1-3 to the index i=3 of the first array_a. A sequence “1” and a volume “3” are set to the auxiliary information sub1-3. The information processing apparatus sets auxiliary information sub1-5 to the index i=5 of the first array_a. A sequence “2” and a volume “5” are set to the auxiliary information sub1-5. The information processing apparatus sets auxiliary information sub1-8 to the index i=8 of the first array_a. A sequence “2” and a volume “5” are set to the auxiliary information sub1-8.

When sequentially accepting the orders Or2-1, Or2-2, and Or2-3, the information processing apparatus sets the second array_a to a state as illustrated in FIG. 5 by executing the processing on the second array_a in a case where a buy order is accepted. The elements of the indexes i=0, 2, 3, 5, 6, 8, 9, and 11 of the second array_a are set to “T”, and other elements of the second array_a are set to “F”. “T” of the index i=0 is set in the initial state.

The information processing apparatus sets auxiliary information sub2-2 to the index i=2 of the second array_a. A sequence “1” and a volume “2” are set to the auxiliary information sub2-2. The information processing apparatus sets auxiliary information sub2-3 to the index i=3 of the second array_a. A sequence “2” and a volume “3” are set to the auxiliary information sub2-3. The information processing apparatus sets auxiliary information sub2-5 to the index i=5 of the second array_a. A sequence “2” and a volume “3” are set to the auxiliary information sub2-5.

The information processing apparatus sets auxiliary information sub2-6 to the index i=6 of the second array_a. A sequence “3” and a volume “6” are set to the auxiliary information sub2-6. The information processing apparatus sets auxiliary information sub2-8 to the index i=8 of the second array_a. A sequence “3” and a volume “6” are set to the auxiliary information sub2-8. The information processing apparatus sets auxiliary information sub2-9 to the index i=9 of the second array_a. A sequence “3” and a volume “6” are set to the auxiliary information sub2-9. The information processing apparatus sets auxiliary information sub2-11 to the index i=11 of the second array_a. A sequence “3” and a volume “6” are set to the auxiliary information sub2-11.

The information processing apparatus compares the first array_a with the second array_a and calculates the largest index among the indexes of which both of the element of the first array_a and the element of the second array_a are set to “T” as the number of executions. In the example illustrated in FIG. 5, the largest index of the indexes of which both of the element of the first array_a and the element of the second array_a are set to “T” is the index i=8. Therefore, the information processing apparatus sets “8” to the number of executions.

After calculating the number of executions, the information processing apparatus specifies execution target orders on the basis of the auxiliary information set to each array_a. In a case where an execution is made with the number of executions i₀, the information processing apparatus sets an initial value of the index as i=i₀ and repeatedly executes the following processing until i=0 is satisfied.

The processing repeated by the information processing apparatus is the following processing. The information processing apparatus sets an order with array_a [i]=T as an execution target. Next, the information processing apparatus specifies a volume a included in auxiliary information set to array_a [i] and updates the index i according to i=i−α.

Processing for specifying a sell order to be executed by the information processing apparatus on the basis of the “first array_a” in FIG. 5 will be described.

The information processing apparatus sets an order corresponding to the auxiliary information sub1-8 set to the index i=8, which corresponds to the number of executions “8”, as an execution target. The auxiliary information sub1-8 corresponds to the order Or1-2 of which the sequence is “2” and the volume is “5”. The information processing apparatus acquires a volume α=5 included in the auxiliary information sub1-8 and updates the index i to the index i=8−5=3.

The information processing apparatus sets an order corresponding to the auxiliary information sub1-3 set to the index i=3 as an execution target. The auxiliary information sub1-3 corresponds to the order Or1-1 of which the sequence is “1” and the volume is “3”. The information processing apparatus acquires a volume α=3 included in the auxiliary information sub1-3 and updates the index i to the index i=3−3=0. Because the index i=0, the information processing apparatus ends the processing.

Processing for specifying a buy order to be executed by the information processing apparatus on the basis of the “second array_a” in FIG. 5 will be described.

The information processing apparatus sets an order corresponding to the auxiliary information sub2-8 set to the index i=8, which corresponds to the number of executions “8”, as an execution target. The auxiliary information sub2-8 corresponds to the order Or2-3 of which the sequence is “3” and the volume is “6”. The information processing apparatus acquires a volume α=6 included in the auxiliary information sub2-8 and updates the index i to the index i=8−6=2.

The information processing apparatus sets an order corresponding to the auxiliary information sub2-2 set to the index i=2 as an execution target. The auxiliary information sub2-2 corresponds to the order Or2-1 of which the sequence is “1” and the volume is “2”. The information processing apparatus acquires a volume α=2 included in the auxiliary information sub2-2 and updates the index i to the index i=2−2=0. Because the index i=0, the information processing apparatus ends the processing.

By the processing described above, the sell orders Or1-1 and Or1-2 and the buy orders Or2-1 and Or2-3 are specified to be the execution targets.

After the execution target orders are specified in the dynamic programming in this way or after an order is cancelled, in a case where an array of an order status regarding remaining orders is obtained, it is not possible to obtain the array from arrays previously created, and an array is reconstructed each time. Therefore, there is a problem in that execution target orders are inefficiently specified, for example, a memory for indexes used to specify orders configuring the maximum execution is consumed.

Therefore, in the present embodiment, the dynamic programming is assumed as multiplication of a polynomial, and the dynamic programming is reduced to polynomials. Specifically, for example, the information processing apparatus according to the present embodiment represents each of the accepted orders as a polynomial using the number of executions as a degree and represents an order status in which the orders are combined as multiplication of a polynomial of each order.

Furthermore, the information processing apparatus according to the present embodiment associates a deduction of the orders used to obtain the order status regarding the remaining orders after specifying the execution target orders or cancelling the order with division of the polynomial.

As a result, by assuming as the polynomial operation in this way, the present embodiment may obtain the order status regarding the remaining orders after the execution target orders are specified or an order is cancelled without combining and reconstructing the orders from the beginning. Therefore, in the present embodiment, it is possible to efficiently specify execution target orders.

For example, an order with a condition such that the number of executions is k shares is represented as x^{k}. Specifically, for example, 1=x⁰ corresponds to “not to execute”, and x³ corresponds to “execute for three shares”. Then, executing an order for three shares is expressed by multiplying by (1+x³). Similarly, executing an order for two shares is expressed by multiplying by (1+x²). Then, a combination of the order for three shares and the order for two shares is represented by multiplication of (1+x³) and (1+x²) as follows, and it is found that it is possible to execute for zero, two, three, and five shares according to the polynomial after the multiplication.

(Combination of orders for three shares and two shares)=(1+x³)(1+x²)=1+x²+x³+x⁵

Note that, in the calculation of the polynomial, it is assumed that “1” correspond to “T” and “0” correspond to “F”, and addition and multiplication are defined as follows. ·Addition includes 0+0=0, 1+0=1, 0+1=1, and 1+1=1. Multiplication includes 0*0=0, 1*0=0, 0*1=0, and 1*1=1.

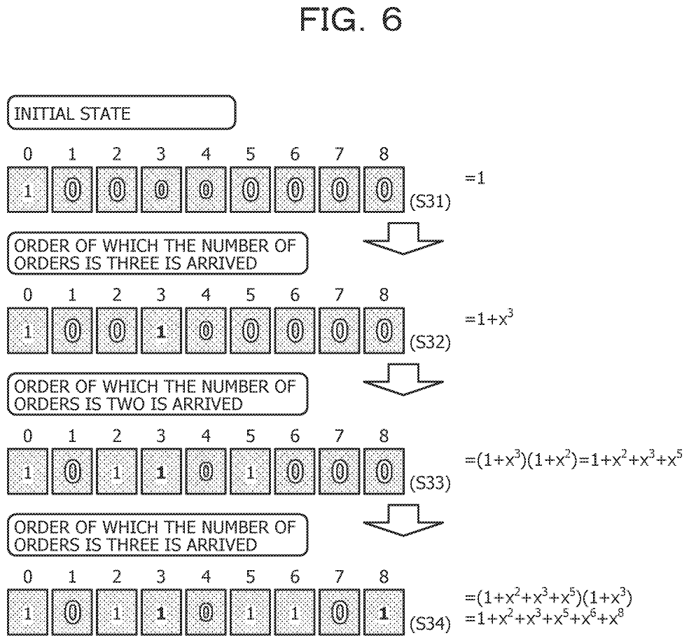

FIG. 6 is an explanatory diagram for explaining a case where an order status is expressed by a polynomial. The left side of FIG. 6 illustrates data stored in a case where the array_a of the order status is represented by a polynomial using the number of executions as a degree of x. In the illustrated example, array_a [0] to array_a [8] respectively store coefficients in the terms of the degrees of zero to eight. The right side in FIG. 6 illustrates a polynomial representing an order.

It is assumed that the initial state of the array_a of the order status be indicated as in step S31. In the initial state of the array_a, array_a [0]=1 is set in correspondence with 1=x° representing that “not to execute”, and all other elements are set to “0”.

Next, in a case where an order of which the number of orders is three is accepted (arrived), the state of the array_a is as indicated in step S32. The information processing apparatus multiplies 1 by a polynomial (1+x³) corresponding to the order of which the number of orders is three. The information processing apparatus sets 1 to array_a [0] and array_a [3] according to a polynomial 1+x³ obtained by this multiplication.

Next, in a case where an order of which the number of orders is two is accepted (arrived), the state of the array_a is as indicated in step S33. The information processing apparatus multiplies (1+x³) by a polynomial (1+x²) corresponding to the order of which the number of orders is two. The information processing apparatus sets 1 to array_a [0], array_a [2], array_a [3], and array_a [5] according to a polynomial 1+x²+x³+x⁵ obtained by this multiplication.

Next, in a case where an order of which the number of orders is three is accepted (arrived), the state of the array_a is as indicated in step S34. The information processing apparatus multiplies (1+x²+x³+x⁵) by a polynomial (1+x³) of which the number of orders is three. The information processing apparatus sets 1 to array_a [0], array_a [2], array_a [3], array_a [5], array_a [6], and array_a [8] according to a polynomial 1+x²+x³+x⁵+x⁶+x⁸ obtained by this multiplication.

The definition described above does not include an inverse operation (subtraction) to addition of T/F (0+0=0, 1+0=1, 0+1=1, 1+1=1) and an inverse operation (division) to multiplication of T/F (0*0=0, 1* 0=0, 0*1=0, 1*1=1). Therefore, in the present embodiment, the number system in the polynomial operation is changed so as to make the operation have reversibility. Specifically, for example, a coefficient of each term in the polynomial operation is replaced with an integer on a finite field Fₚ obtained by dividing the coefficient by a prime number p. As a result, the information processing apparatus according to the present embodiment sets the polynomial representing the order status as a polynomial on the finite field and makes it possible to obtain a state (polynomial) on which an order is canceled by a reverse operation (for example, division).

As an example, in a case where the prime number p is set to p=7 (mod 7), replacement with any one of integers {0, 1, 2, 3, 4, 5, 6} is performed. For example, the addition is 3+5=8 ≡1. Furthermore, the subtraction is 3−5=−2≡5. Furthermore, the multiplication is 3*5=15 ≡1. Furthermore, the division is 3/5=3*3=9 ≡2 (because when three multiplied by five equals one, “dividing by five” is the same as “multiplying by three”). In this way, it is possible to assume the polynomial operation as a set of a finite number of elements that may be added, subtracted, multiplied, and divided. In this way, by setting the number as the finite number, the number is easily used for a computer operation. Note that it is assumed that the prime number p used for an actual operation be a sufficiently large value to be corresponded to the number of orders to be combined.

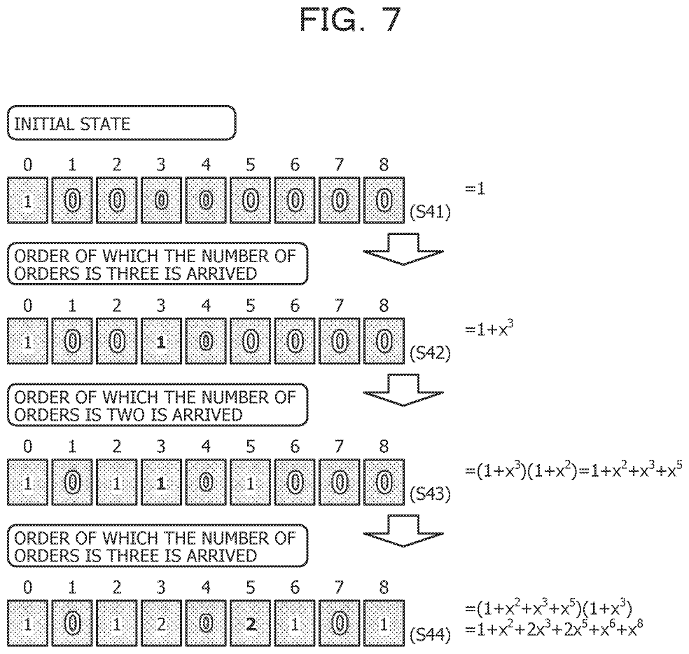

FIG. 7 is an explanatory diagram for explaining a case where an order status is represented by a polynomial. As in FIG. 6, the left side of FIG. 7 illustrates the array_a of the order status, and the right side of FIG. 7 illustrates a polynomial representing an order.

It is assumed that an initial state of the array_a of the order status be as indicated in step S41. In the initial state of the array_a, array_a [0]=1 is set in correspondence with 1=x° representing that “not to execute”, and all other elements are set to “0”.

Next, in a case where an order of which the number of orders is three is accepted (arrived), the state of the array_a is as indicated in step S42. The information processing apparatus multiplies 1 by a polynomial (1+x³) corresponding to the order of which the number of orders is three. Note that it is assumed that the information processing apparatus replace a coefficient of each term with an integer on the finite field Fₚ divided by the prime number p (mod p) in the polynomial operation (for example, multiplication). The information processing apparatus sets 1 to array_a [0] and array_a [3] according to a polynomial 1+x³ obtained by this multiplication (all other elements are set to zero).

Next, in a case where an order of which the number of orders is two is accepted (arrived), the state of the array_a is as indicated in step S43. The information processing apparatus multiplies (1+x³) by a polynomial (1+x²) corresponding to the order of which the number of orders is two. The information processing apparatus sets 1 to array_a [0], array_a [2], array_a [3], and array_a [5] according to a polynomial 1+x²+x³+x⁵ obtained by this multiplication (all other elements are set to zero).

Next, in a case where an order of which the number of orders is three is accepted (arrived), the state of the array_a is as indicated in step S44. The information processing apparatus multiplies (1+x²+x³+x⁵) by a polynomial (1+x³) of which the number of orders is three. The information processing apparatus sets 1 to array_a [0] and array_a [2], sets 2 to array_a [3] and array_a [5], and sets 1 to array_a [6] and array_a [8] according to a polynomial 1+x²+2x³+2x⁵+x⁶+x⁸ obtained by this multiplication (all other elements are set to zero).

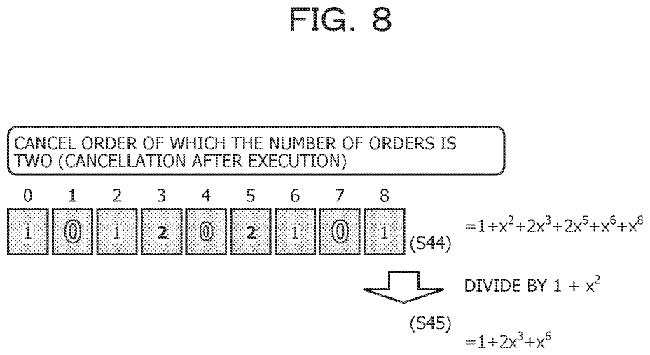

FIG. 8 is an explanatory diagram for explaining division in a case where an order status is represented by a polynomial. As illustrated in FIG. 8, in a case where an order of which the number of orders is two is cancelled (or canceling after execution) from the state of the order in the array_a in step S44, the information processing apparatus performs division by (1+x²). As a result, the information processing apparatus updates the polynomial (array_a) on the finite field representing the order status to a polynomial indicating an order status after the order of which the number of orders is two is executed or cancelled.

Specifically, for example, the information processing apparatus divides 1+x²+2x³+2x⁵+x⁶+x⁸ in the array_a in step S44 by (1+x²). The information processing apparatus sets 1 to array_a [0] and array_a [6] and sets 2 to array_a [3] according to a polynomial 1+2x³+x⁶ obtained by this division (all other elements are set to zero).

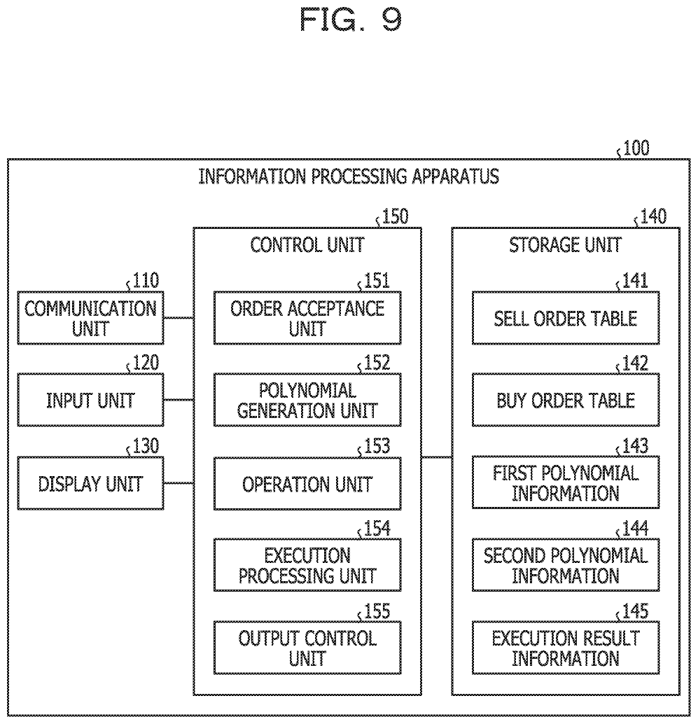

FIG. 9 is a block diagram illustrating an exemplary functional configuration of the information processing apparatus according to the embodiment. As illustrated in FIG. 9, an information processing apparatus 100 includes a communication unit 110, an input unit 120, a display unit 130, a storage unit 140, and a control unit 150.

The communication unit 110 is wired or wirelessly coupled to an external device or the like and exchanges information with the external device or the like. For example, the communication unit 110 is implemented by a network interface card (NIC) or the like. The communication unit 110 may be coupled to a network (not illustrated). For example, the communication unit 110 receives information regarding a sell order table 141 including information regarding sell orders, information regarding a buy order table 142 including information regarding buy orders, or the like from the external device. For example, the external device corresponds to a server that manages buying and selling of stocks and executes various types of processing on execution target orders.

The input unit 120 is an input device that inputs various types of information to the information processing apparatus 100. The input unit 120 corresponds to a keyboard, a mouse, a touch panel, and the like.

The display unit 130 is a display device that displays information output from the control unit 150. The display unit 130 corresponds to a liquid crystal display, an organic electro luminescence (EL) display, a touch panel, or the like.

The storage unit 140 includes the sell order table 141, the buy order table 142, first polynomial information 143, second polynomial information 144, and execution result information 145. The storage unit 140 is implemented, for example, by a semiconductor memory element such as a random access memory (RAM) or a flash memory, or a storage device such as a hard disk or an optical disk.

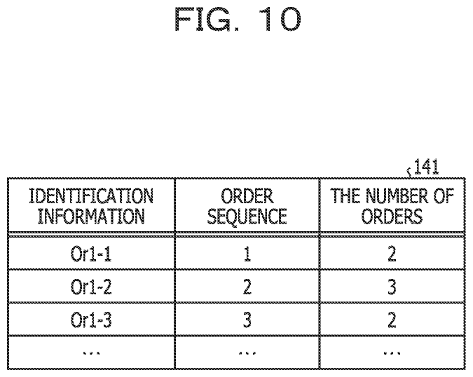

The sell order table 141 is a table that holds an order sequence and the number of orders of a sell order. FIG. 10 is an explanatory diagram illustrating an example of a data structure of the sell order table 141. As illustrated in FIG. 10, the sell order table 141 associates identification information, the order sequence, and the number of orders. The identification information is information that uniquely identifies an order. The order sequence is a sequence of an accepted sell order. The number of orders is the number of sell orders.

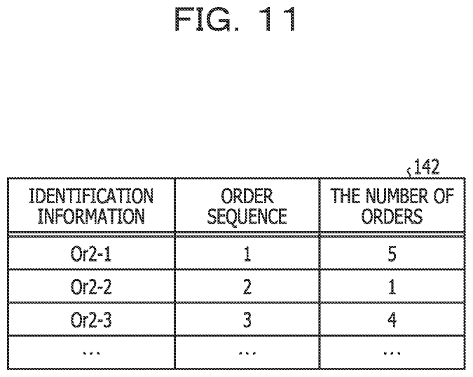

The buy order table 142 is a table that holds an order sequence and the number of orders of a buy order. FIG. 11 is an explanatory diagram illustrating an example of a data structure of the buy order table 142. As illustrated in FIG. 11, the buy order table 142 associates identification information, the order sequence, and the number of orders. The identification information is information that uniquely identifies an order. The order sequence is a sequence of an accepted buy order. The number of orders is the number of buy orders.

The first polynomial information 143 is array information that holds information regarding a polynomial corresponding to an order status in which orders related to sell orders are combined. Specifically, for example, the first polynomial information 143 is array information of a polynomial (array_a) on a finite field representing a status of a sell order obtained by multiplying by a polynomial corresponding to each sell order.

The second polynomial information 144 is array information that holds information regarding a polynomial corresponding to an order status in which orders related to buy orders are combined. Specifically, for example, the second polynomial information 144 is array information of a polynomial (array_a) on a finite field representing a status of a buy order obtained by multiplying by a polynomial corresponding to each buy order.

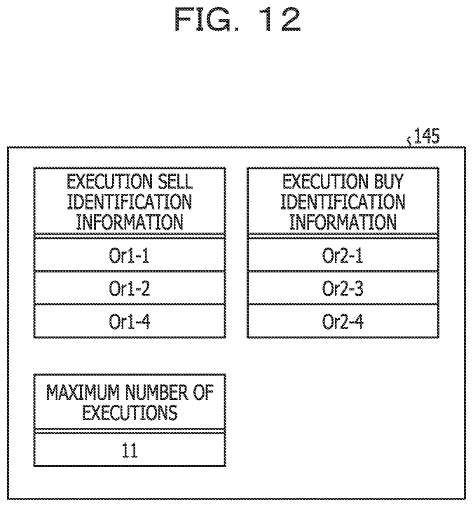

The execution result information 145 holds information regarding the maximum number of executions and execution target orders. FIG. 12 is an explanatory diagram illustrating an example of a data structure of the execution result information 145. As illustrated in FIG. 12, the execution result information 145 includes execution sell identification information, execution buy identification information, and the maximum number of executions. The execution sell identification information is information that identifies a sell order to be an execution target. The execution buy identification information is information that identifies a buy order to be an execution target. The maximum number of executions indicates the largest number of executions.

The control unit 150 includes an order acceptance unit 151, a polynomial generation unit 152, an operation unit 153, an execution processing unit 154, and an output control unit 155. The control unit 150 is implemented by, for example, a central processing unit (CPU) or a micro processing unit (MPU). Furthermore, for example, the control unit 150 may be implemented by an integrated circuit such as an application specific integrated circuit (ASIC) or a field programmable gate array (FPGA).

The order acceptance unit 151 is a processing unit that accepts an order of which a condition of the number of executions is designated. In a case of acquiring data of the sell order table 141 from an external device or the like, the order acceptance unit 151 stores the data of the sell order table 141 in the storage unit 140. The order acceptance unit 151 may individually acquire sell orders sequentially and register information regarding the acquired sell orders to the sell order table 141.

In a case of acquiring data of the buy order table 142 from an external device or the like, the order acceptance unit 151 stores the data of the buy order table 142 in the storage unit 140. The order acceptance unit 151 may individually acquire buy orders sequentially and register information regarding the acquired buy orders to the buy order table 142.

Furthermore, the order acceptance unit 151 may accept information (identification information) regarding an order to be canceled and delete the information regarding the sell order or the buy order registered in the sell order table 141 or the buy order table 142. At this time, the order acceptance unit 151 acquires the information regarding the order to be deleted from the sell order table 141 or the buy order table 142 and notifies the operation unit 153 of the information.

The polynomial generation unit 152 is a processing unit that generates a polynomial on a finite field representing an order status in which accepted orders are combined (hereinafter, also referred to as existing polynomial). The polynomial generation unit 152 sets each of the accepted orders as a polynomial of which the number of executions (the number of orders) under the condition designated in the order is a degree. Next, the polynomial generation unit 152 represents the order status in which the accepted orders are combined as a polynomial (existing polynomial) on a finite field according to a product of the polynomials.

Specifically, for example, the polynomial generation unit 152 sets each of the sell orders as a polynomial of which the number of orders designated in the sell order is a degree, on the basis of the sell order table 141 regarding the sell orders. Next, the polynomial generation unit 152 generates a polynomial (first existing polynomial) on the finite field corresponding to the order status of the sell orders, in which the accepted sell orders are combined, by multiplying the polynomial of each sell order. Next, the polynomial generation unit 152 stores information regarding the generated polynomial in the storage unit 140 as the first polynomial information 143.

Furthermore, the polynomial generation unit 152 sets each of the buy orders as a polynomial of which the number of orders designated in the buy order is a degree, on the basis of the buy order table 142 regarding the buy orders. Next, the polynomial generation unit 152 generates a polynomial (second existing polynomial) on the finite field corresponding to the order status of the buy orders, in which the accepted buy orders are combined, by multiplying the polynomial of each buy order. Next, the polynomial generation unit 152 stores information regarding the generated polynomial in the storage unit 140 as the second polynomial information 144.

The operation unit 153 is a processing unit that executes various types of operation processing on the polynomial on the finite field representing the order status. Specifically, for example, the operation unit 153 divides the polynomial (existing polynomial) on the finite field representing the order status by the polynomial corresponding to the order to be executed or canceled and updates the polynomial to an existing polynomial representing an order status after the execution or cancellation. For example, the operation unit 153 divides the existing polynomial of the first polynomial information 143 or the second polynomial information 144 by the polynomial corresponding to the order specified as an execution target by the execution processing unit 154 or the order to be canceled (deleted) notified by the order acceptance unit 151. Next, the operation unit 153 stores information regarding the existing polynomial on which division has been performed in the storage unit 140 as the first polynomial information 143 or the second polynomial information 144.

More specifically, for example, in a case where the order to be executed or canceled is a sell order, the operation unit 153 generates a polynomial corresponding to the sell order to be executed or canceled according to the method similar to the polynomial generation unit 152. Next, the operation unit 153 divides the first existing polynomial of the first polynomial information 143 by the generated polynomial and obtains a first existing polynomial corresponding to a status of the sell order after the execution or cancellation. Next, the operation unit 153 stores information regarding the obtained first existing polynomial in the storage unit 140 as the first polynomial information 143.

Furthermore, in a case where the order to be executed or canceled is a buy order, the operation unit 153 generates a polynomial corresponding to the buy order to be executed or canceled according to the method similar to the polynomial generation unit 152. Next, the operation unit 153 divides the second existing polynomial of the second polynomial information 144 by the generated polynomial and obtains a second existing polynomial corresponding to a status of the buy order after the execution or cancellation. Next, the operation unit 153 stores information regarding the obtained second existing polynomial in the storage unit 140 as the second polynomial information 144.

Furthermore, the operation unit 153 may determine whether or not to adopt the existing polynomial after division as an existing polynomial representing an order status after the execution or cancellation on the basis of a coefficient of a term of a specific degree. For example, regarding a result obtained by dividing the existing polynomial by the polynomial corresponding to the execution target or cancellation target order, if the coefficient of the specific term is not zero, the operation unit 153 adopts the existing polynomial after division, and if the coefficient is zero, the operation unit 153 does not adopt the existing polynomial after division.

As an example, in a case where the existing polynomial is 1+x²+2x³+2x⁵+x⁶+x⁸, an execution for six shares (possible because coefficient of x⁶ is not zero) is discussed. When it is desired to determine whether or not the execution includes an order for two shares, the original formula (existing polynomial described above) is divided by 1+x². In the division result 1+2x³+x⁶, a coefficient of a term x⁴ (four shares according to 6-2=4) is zero. Therefore, it is understood that the order for two shares is not included.

In this way, the operation unit 153 may determine to adopt or not to adopt the existing polynomial after division on the basis of the coefficient of the specific term in the existing polynomial after division. In a case where the existing polynomial after division is not adopted, the operation unit 153 may notify an error by the output control unit 155 or may return the processing to the execution processing unit 154 so as to set another order as an execution target.

For example, in a case where the prime number p when the finite field is assumed is smaller than the number of combined orders, there is a case where a coefficient in the operated existing polynomial is falsely positive. Therefore, the information processing apparatus 100 may eliminate a case where the coefficient is falsely positive by determining to adopt or not to adopt the existing polynomial after division on the basis of the coefficient of the specific term.

Furthermore, in a case where a newly added order is accepted from the order acceptance unit 151, the operation unit 153 may perform update to an existing polynomial representing an order status after addition by multiplying the existing polynomial by the polynomial of the newly added order.

For example, in a case where the newly added order is a sell order, the operation unit 153 generates a polynomial corresponding to the sell order to be added according to the method similar to the polynomial generation unit 152. Next, the operation unit 153 multiplies the first existing polynomial of the first polynomial information 143 by the generated polynomial and obtains a first existing polynomial corresponding to a state after addition of the sell order. Next, the operation unit 153 stores information regarding the obtained first existing polynomial in the storage unit 140 as the first polynomial information 143.

Furthermore, in a case where the newly added order is a buy order, the operation unit 153 generates a polynomial corresponding to the buy order to be added according to the method similar to the polynomial generation unit 152. Next, the operation unit 153 multiplies the second existing polynomial of the second polynomial information 144 by the generated polynomial and obtains a second existing polynomial corresponding to a state after addition of the buy order. Next, the operation unit 153 stores information regarding the obtained second existing polynomial in the storage unit 140 as the second polynomial information 144.

The execution processing unit 154 is a processing unit that specifies execution target orders on the basis of the maximum number of executions, the first polynomial information 143, and the second polynomial information 144. Processing of the execution processing unit 154 corresponds to the processing described with reference to FIG. 5.

For example, as described with reference to FIG. 5, the execution processing unit 154 specifies identification information Or1-1 and Or1-2 of execution target orders by executing the above processing on the first array_a (first polynomial information 143). The execution processing unit 154 specifies identification information Or2-1 and Or2-3 of execution target orders by executing the above processing on the second array_a (second polynomial information 144).

Next, the execution processing unit 154 registers the identification information of the execution target orders specified by executing the above processing to the execution result information 145. Furthermore, the execution processing unit 154 acquires information regarding the execution target orders from the sell order table 141 or the buy order table 142 and notifies the operation unit 153 of the acquired information.

The output control unit 155 is a processing unit that outputs the execution result information 145 to the display unit 130 and makes the display unit 130 display the execution result information 145. The output control unit 155 may transmit the execution result information 145 to an external device and request various types of execution processing.

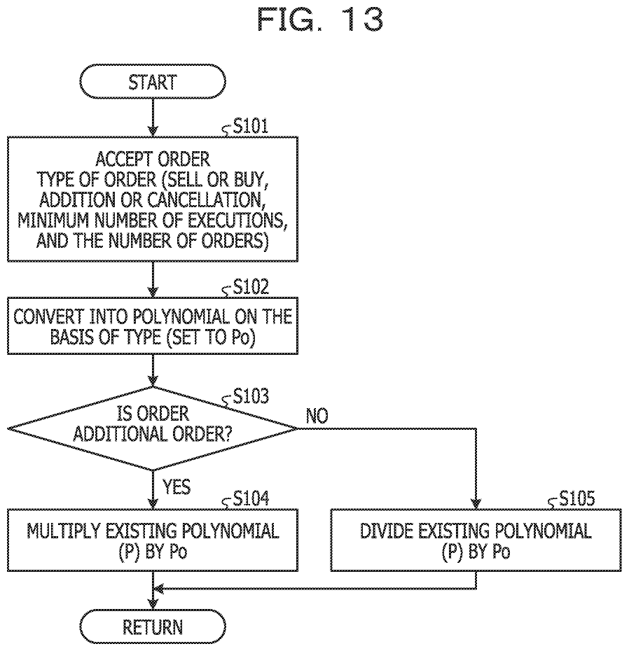

FIG. 13 is a flowchart illustrating an example of order acceptance and cancellation processing. As illustrated in FIG. 13, when the processing is started, the order acceptance unit 151 accepts an order to which a condition of the number of executions is designated (S101). Types (conditions) of the order accepted in S101 include a sell order or a buy order, addition or cancellation of orders, the minimum number of executions, the number of orders, or the like.

Next, the polynomial generation unit 152 converts the order into a polynomial (Po) of which the number of executions (the number of orders) under the conditions designated in the order is set as a degree on the basis of the type (condition) of the accepted order (S102). Note that, in a case where the condition of the number of executions varies, as in a case where the minimum number of executions is a (for example, three shares) and the number of orders is b (for example, five shares), the polynomial generation unit 152 converts the order to a polynomial of which the numbers of executions for a to b shares are set as degrees. Specifically, for example, the polynomial generation unit 152 performs the conversion into a polynomial of 1+x^{a}+x^{a+1}+x^{a+2}+ . . . +x^{b}.

Next, the operation unit 153 determines whether or not the accepted order is an additional order (S103). In a case of the additional order (S103: Yes), the operation unit 153 reads the first polynomial information 143 in a case where the additional order is a sell order and reads the second polynomial information 144 in a case where the additional order is a buy order and acquires an existing polynomial (P). Next, the operation unit 153 multiplies the acquired existing polynomial (P) by the polynomial (Po) (S104). Next, the operation unit 153 updates the first polynomial information 143 or the second polynomial information 144 according to the existing polynomial (P) after multiplication and ends the processing.

In a case of the order calculation, not the additional order (S103: No), the operation unit 153 reads the first polynomial information 143 in a case where the order to be canceled is a sell order and reads the second polynomial information 144 in a case where the order to be canceled is a buy order and acquires an existing polynomial (P). Next, the operation unit 153 divides the acquired existing polynomial (P) by the polynomial (Po) (S105). Next, the operation unit 153 updates the first polynomial information 143 or the second polynomial information 144 according to the existing polynomial (P) after division and ends the processing.

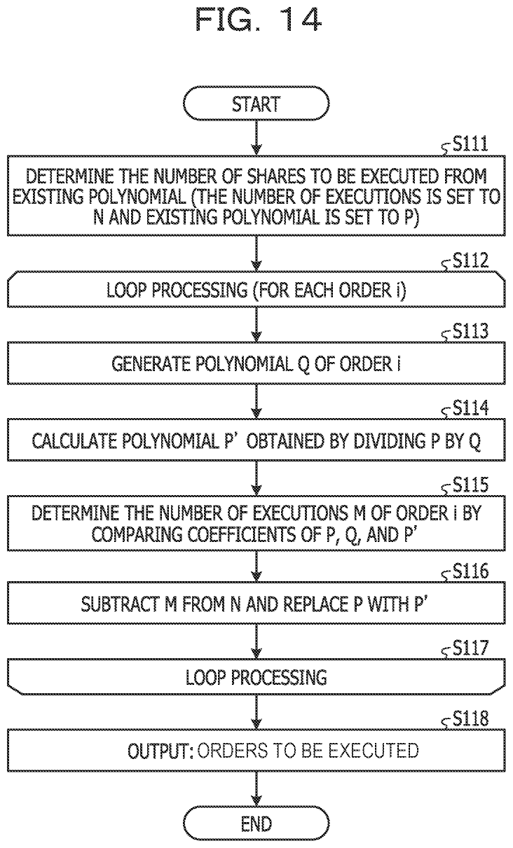

FIG. 14 is a flowchart illustrating an example of execution processing. As illustrated in FIG. 14, when the processing is started, the execution processing unit 154 determines the number of shares to be executed from the existing polynomials of the first polynomial information 143 and the second polynomial information 144 (first existing polynomial and second existing polynomial) (S111). Specifically, for example, the execution processing unit 154 compares the first existing polynomial with the second existing polynomial and determines the maximum number (maximum degree) with which the first existing polynomial and the second existing polynomial are set to T (coefficient other than zero is set) as the number of shares to be executed. Here, the determined number of executions is indicated as N, and the existing polynomial is indicated as P.

Next, the execution processing unit 154 executes loop processing (S112 to S117) on execution target orders for each of sell orders and buy orders and specifies execution target orders. For example, in a case of FIG. 5, sell orders of which identification information is Or1-1 and Or1-2 and buy orders of which identification information is Or2-1 and Or2-3 are the execution target orders. The execution processing unit 154 executes the loop processing while setting each of these orders as i.

Specifically, for example, the execution processing unit 154 generates a polynomial Q on the basis of conditions of the order i (S113). Next, the operation unit 153 calculates a polynomial P′ obtained by dividing the existing polynomial P (first existing polynomial in a case where order i is sell order and second existing polynomial in a case where order i is buy order) by the polynomial Q (S114).

Next, the execution processing unit 154 determines the number of executions M of the order i by comparing coefficients of P, Q, and P′ (S115). In polynomial calculation P (x)=Q (x)*P′ (x), assume that the coefficient of x^{N} of P (x) is c. If c is not zero, there is a case where c₁≠c₂ is satisfied regarding c₁x^{N-M} of Q (x) and c₂x^{N} of P (x). The execution processing unit 154 determines M that satisfies the conditions described above. Note that, when M is zero, this indicates that zero shares are executed, that is, for example, the order i is not executed.

Next, the execution processing unit 154 subtracts the determined number of executions M from N and replaces the existing polynomial P with P′ (S116).

Following the loop processing (S112 to S117), the execution processing unit 154 outputs the specified execution target orders (S118) and ends the processing.

As described above, the information processing apparatus 100 accepts orders of which the conditions of the number of executions are designated. The information processing apparatus 100 sets each of the accepted orders as a polynomial using the number of executions under the designated conditions as a degree. The information processing apparatus 100 represents the order status in which the accepted orders are combined as a polynomial on a finite field according to a product of polynomials. The information processing apparatus 100 divides the polynomial on the finite field representing the order status by the polynomial corresponding to the order to be executed or canceled to update the polynomial on the finite field to represent the order status after the execution or cancellation.

As a result, the information processing apparatus 100 may obtain an order status regarding remaining orders after the execution target orders are specified or the order is cancelled without combining and reconstructing the orders from the beginning. Therefore, the information processing apparatus 100 may efficiently specify execution target orders.

The information processing apparatus 100 represents a buy order status in which accepted buy orders are combined as a first polynomial on the finite field according to the product of polynomials. The information processing apparatus 100 represents a sell order status in which accepted sell orders are combined as a second polynomial on the finite field according to the product of polynomials. As a result, the information processing apparatus 100 may efficiently obtain an order status after the execution target orders are specified or an order is canceled for each of the buy order status in which the buy orders are combined and the sell order status in which the sell orders are combined.

Furthermore, the information processing apparatus 100 determines whether or not to adopt the polynomial on the finite field after division as a polynomial on the finite field representing the order status after the execution or cancellation on the basis of a coefficient of a term of a specific degree. In this way, the information processing apparatus 100 may determine to adopt or not to adopt the polynomial on the finite field after division on the basis of the coefficient of the term of the specific degree. As a result, for example, the information processing apparatus 100 may eliminate a case where the coefficient in the existing polynomial after the operation is falsely positive.

Note that each of the illustrated components in each of the devices is not necessarily physically configured as illustrated in the drawings. In other words, for example, the specific aspects of distribution and integration of the respective devices are not limited to the illustrated aspects, and all or some of the devices may be functionally or physically distributed and integrated in any unit in accordance with various loads, use status, and the like.

Furthermore, in the present embodiment, a case has been described where an order is placed under conditions such as a full-volume execution or a certain number of orders in stock transactions in the securities market. However, the application is not limited to the application to the stock transactions. For example, this case may be applied to transactions in the futures-transactions market or the like other than stock transactions.

Various processing functions executed by the information processing apparatus 100 may be entirely or optionally partially executed by a CPU (or microcomputer such as MPU or micro controller unit (MCU)) or a graphics processing unit (GPU). Furthermore, all or some of the various processing functions may of course be executed by a program to be analyzed and executed by a CPU (or microcomputer such as MPU or MCU) or a GPU or hardware using wired logic. Furthermore, the various processing functions executed by the information processing apparatus 100 may be executed by a plurality of computers in cooperation through cloud computing.

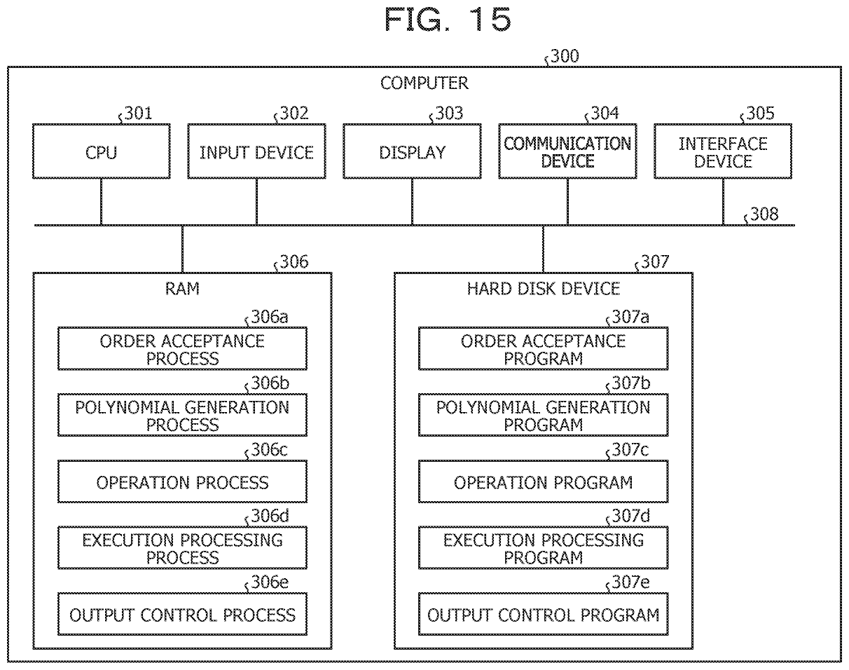

Next, an exemplary hardware configuration of a computer that implements functions similar to those of the information processing apparatus 100 described in the embodiment above will be described. FIG. 15 is a diagram illustrating an exemplary hardware configuration of the computer that implements the functions similar to those of the information processing apparatus 100 according to the embodiment.

As illustrated in FIG. 15, a computer 300 includes a CPU 301 that executes various types of operation processing, an input device 302 that accepts data input from a user, and a display 303. Furthermore, the computer 300 includes a communication device 304 that exchanges data with an external device or the like via a wired or wireless network and an interface device 305. Furthermore, the computer 300 includes a RAM 306 which temporarily stores various types of information and a hard disk device 307. Then, each of the devices 301 to 307 is coupled to a bus 308.

The hard disk device 307 includes an order acceptance program 307a, a polynomial generation program 307b, an operation program 307c, an execution processing program 307d, and an output control program 307e. The CPU 301 reads each of the programs 307a to 307e, and loads it to the RAM 306.

The order acceptance program 307a functions as an order acceptance process 306a. The polynomial generation program 307b functions as a polynomial generation process 306b. The operation program 307c functions as an operation process 306c. The execution processing program 307d functions as an execution processing process 306d. The output control program 307e functions as an output control process 306e.

Processing of the order acceptance process 306a corresponds to the processing of the order acceptance unit 151. Processing of the polynomial generation process 306b corresponds to the processing of the polynomial generation unit 152. Processing of the operation process 306c corresponds to the processing of the operation unit 153. Processing of the execution processing process 306d corresponds to the processing of the execution processing unit 154. Processing of the output control process 306e corresponds to the processing of the output control unit 155.

Note that each of the programs 307a to 307e may not need to be stored in the hard disk device 307 beforehand. For example, each of the programs is stored in a “portable physical medium” to be inserted in the computer 300, such as a flexible disk (FD), a compact disc read only memory (CD-ROM), a digital versatile disc (DVD), a magneto-optical disk, or an IC card. Then, the computer 300 may read and execute each of the programs 307a to 307e. Furthermore, each of the programs 307a to 307e may be stored in an external device coupled to a network such as a public line, the Internet, or a local area network (LAN), and the computer 300 may read each of the programs 307a to 307e from the external device coupled to the network and execute the programs.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an execution program for causing a computer to execute a process, the process comprising:
accepting orders to each of which a condition of a number of executions is designated;
setting the accepted orders as respective polynomials using the designated number of executions in the condition as a degree;
representing an order status in which the accepted orders are combined as a polynomial on a finite field according to a product of the polynomials;
dividing the polynomial on the finite field by a polynomial that corresponds to an order to be executed or canceled; and
updating the polynomial on the finite field to a resulted polynomial after the division.

2. The non-transitory computer-readable recording medium according to claim 1, the process further comprising:
outputting the order to be executed to request execution processing.

3. The non-transitory computer-readable recording medium according to claim 1, the process further comprising:
representing a buy order status in which accepted buy orders are combined as a first polynomial on the finite field according to a product of polynomials corresponding to the buy orders; and
representing a sell order status in which accepted sell orders are combined as a second polynomial on the finite field according to a product of polynomials corresponding to the sell orders.

4. The non-transitory computer-readable recording medium according to claim 1, the process further comprising:
determining whether to adopt the resulted polynomial after the division as a polynomial on the finite field that represents an order status after the execution or the cancellation on a basis of a coefficient of a term of a specific degree in the resulted polynomial after the division.

5. An execution method, comprising:
accepting, by a computer, orders to each of which a condition of a number of executions is designated;
setting the accepted orders as respective polynomials using the designated number of executions in the condition as a degree;
representing an order status in which the accepted orders are combined as a polynomial on a finite field according to a product of the polynomials;
dividing the polynomial on the finite field by a polynomial that corresponds to an order to be executed or canceled; and
updating the polynomial on the finite field to a resulted polynomial after the division.

6. The execution method according to claim 5, further comprising:
outputting the order to be executed to request execution processing.

7. The execution method according to claim 5, further comprising:
representing a buy order status in which accepted buy orders are combined as a first polynomial on the finite field according to a product of polynomials corresponding to the buy orders; and
representing a sell order status in which accepted sell orders are combined as a second polynomial on the finite field according to a product of polynomials corresponding to the sell orders.

8. The execution method according to claim 5, further comprising:
determining whether to adopt the resulted polynomial after the division as a polynomial on the finite field that represents an order status after the execution or the cancellation on a basis of a coefficient of a term of a specific degree in the resulted polynomial after the division.

9. An information processing apparatus, comprising:
a memory; and
a processor coupled to the memory and the processor configured to:
accept orders to each of which a condition of a number of executions is designated;
set the accepted orders as respective polynomials using the designated number of executions in the condition as a degree;
represent an order status in which the accepted orders are combined as a polynomial on a finite field according to a product of the polynomials;
divide the polynomial on the finite field by a polynomial that corresponds to an order to be executed or canceled; and
update the polynomial on the finite field to a resulted polynomial after the division.

10. The information processing apparatus according to claim 9,
the processor is further configured to:
output the order to be executed to request execution processing.

11. The information processing apparatus according to claim 9,
the processor is further configured to:
represent a buy order status in which accepted buy orders are combined as a first polynomial on the finite field according to a product of polynomials corresponding to the buy orders; and
represent a sell order status in which accepted sell orders are combined as a second polynomial on the finite field according to a product of polynomials corresponding to the sell orders.

12. The information processing apparatus according to claim 9,
the processor is further configured to:
determine whether to adopt the resulted polynomial after the division as a polynomial on the finite field that represents an order status after the execution or the cancellation on a basis of a coefficient of a term of a specific degree in the resulted polynomial after the division.
